(19) United States
(12) Patent Application Publication
(10) Pub. No.: US 2024/0381465 A1
(43) Pub. Date: Nov. 14, 2024

(54) METHODS AND APPARATUSES FOR COORDINATED OPERATIONS IN A MULTIPLE ACCESS POINT MULTI-LINK DEVICE SET IN A WIRELESS LOCAL AREA NETWORK

(71) Applicant: InterDigital Patent Holdings, Inc., Wilmington, DE (US)

(72) Inventors: Xiaofei Wang, North Caldwell, NJ (US); Hanqing Lou, Syosset, NY (US); Zinan Lin, Basking Ridge, NJ (US); Joseph Levy, Merrick, NY (US)

(73) Assignee: InterDigital Patent Holdings, Inc., Wilmington, DE (US)

(21) Appl. No.: 18/689,640

(22) PCT Filed: Oct. 6, 2022
(86) PCT No.: PCT/US2022/045916

§ 371 Date: Mar. 6, 2024

Related U.S. Application Data
(60) Provisional application No. 63/253,849, filed on Oct. 8, 2021.

(51) Int. Cl. H04W 76/15; H04W 48/08

(52) U.S. Cl. CPC H04W 76/15; H04W 48/08

(57) ABSTRACT

A method performed by a multi-multi-link device (MMLD) architecture comprising a plurality of access points (APs) may comprise transmitting a frame, by an AP of the MMLD, wherein the frame may include a multi-multi-link device (MMLD) frame element which indicates that the AP is part of a multi-link device (MLD) that is a MMLD. The frame may comprise a beacon, short beacon, probe response, fast initial link setup (FILS) discovery frame, association response frame, or the like, or any appropriate combination thereof. The MMLD element may comprise one or more of an element identifier, length, MMLD identifier, MMLD media access control (MAC) address, partial reporting field, number of reported MLDs field and/or an MLD info field. The MLD may communicate with other MLDs of the multiple MLDs during a transmit wake time (TWT) service period (SP). The MLD may be in a doze state during non-TWT SPs.

### CROSS-REFERENCE TO RELATED APPLICATIONS

This application claims the benefit of U.S. Provisional Patent Application No. 63/253,849, filed Oct. 8, 2021, the entirety of which is incorporated by reference herein.

### FIELD OF INVENTION

The herein disclosure generally is directed to the field of telecommunications, and in a more specific example, coordinated operations of multiple multi-link-devices in wireless local area networks.

### BACKGROUND

Advancements in telecommunications are making it possible for more and more devices, such as wireless communication devices, to communicate with each other. Additionally, advancements in telecommunications are making it possible for wireless communications device to process, transmit, and receive increasing amounts of data at faster data rates. Further, networks are expected to accommodate more and more wireless devices.

### SUMMARY

A multi-Multi-Link-Device (MMLD) architecture/network (also referred to herein as a MMLD) may comprise a plurality of access points (APs) or stations (STAs). Each AP or STA may be part of a physical device, which may be a multi-link device (MLD). Each MLD may comprise one or more APs or STAs. MLDs may be located in the same physical location or different physical locations. A STA may be an AP STA or a non-AP STA. A MLD may be an AP MLD or a non-AP MLD. An AP MMLD is a MMLD in which STAs affiliated with the MMLD are APs. In an example, an AP MMLD is a MMLD in which each MLD affiliated with the MMLD is an AP MLD. A non-AP MMLD is a MMLD in which the STAs affiliated with the MMLD are non-AP STAs. In an example, a non-AP MMLD is a MMLD in which each MLD affiliated with the MMLD is a non-AP MLD.

A method performed by a MMLD comprising a plurality of APs may comprise transmitting, by an AP multi-link-device (AP MLD) of the MMLD, a frame. The frame may include at least one MMLD element which may indicate that the AP is part of a MLD that is a part of a MMLD. The frame may be a beacon, short beacon, probe response, fast initial link setup (FILS) discovery frame, association response frame, or the like, or any appropriate combination thereof. A MMLD element may comprise one or more of an element identifier, length, MMLD identifier, MMLD media access control (MAC) address, partial reporting field, number of reported MLDs field and/or an MLD info field.

Multi-link operation in accordance with IEEE 802.11be Extremely High Throughput (EHT) may enable the utilization of multiple links simultaneously using individual frequency channels to transmit and receive between extremely high throughput (EHT) devices.

In an example, a MLD capable of communicating on a plurality of links simultaneously, may receive a frame comprising an indication that a provider of the frame is affiliated with a MMLD comprising a plurality of MLDs. The MLD may provide a message comprising an indication that the MLD supports MMLD operations. The MLD may receive information for establishing communications on the plurality of links. In an example embodiment, the MLD may comprise a station (STA) and the plurality of MLDs may comprise a respective plurality of STAs. In an example embodiment, the provider of the frame may comprise an AP. The information for establishing communications on the plurality of links may be provided by the provider of the frame. In an example embodiment, the frame may comprise a beacon, a short beacon, a probe response, a fast initial link setup (FILS) discovery frame, an association response frame, or the like, or any appropriate combination thereof. In an example embodiment, the frame may comprise an MMLD element, and the MMLD element may comprise an element ID field, a length field, an element identifier (ID) field, and element ID extension field, a MMLD ID field, a MMLD media access control (MAC) Address field, a partial reporting field, a number of reported MLDs field, a MLD information field, or the like, or any appropriate combination thereof. The method further may include providing, by the MLD, a transmit wake time (TWT) request message to establish a TWT agreement. The MLD may receive a TWT response message comprising an indication that the TWT agreement is accepted. The MLD may be configured to communicate on the plurality of links in accordance with the TWT agreement. The TWT agreement may establish at least one trigger-enabled TWT service period (SP), during which communications may occur. The MLD may be in a doze state when not in a TWT SP.

An example MLD may be configured to perform the above-described method. For example, a MLD capable of communicating on a plurality of links simultaneously may comprise a transceiver and a processor. The processor may be configured to receive, via the transceiver, a frame comprising an indication that a provider of the frame is affiliated with a MMLD comprising a plurality of MLDs. The processor of the MLD may provide a message, via the transceiver, wherein the message may comprise an indication that the MLD supports MMLD operations. The MLD may receive, via the transceiver, information for establishing communications on the plurality of links. In an example embodiment, the MLD may comprise a station (STA) and the plurality of MLDs may comprise a respective plurality of STAs. In an example embodiment, the provider of the frame may comprise an AP. The information for establishing communications on the plurality of links may be provided by the provider of the frame. In an example embodiment, the frame may comprise a beacon, a short beacon, a probe response, a fast initial link setup (FILS) discovery frame, an association response frame, or the like, or any appropriate combination thereof. In an example embodiment, the frame may comprise an MMLD element, and the MMLD element may comprise an element ID field, a length field, an element identifier (ID) field, and element ID extension field, a MMLD ID field, a MMLD media access control (MAC) Address field, a partial reporting field, a number of reported MLDs field, a MLD information field, or the like, or any appropriate combination thereof. The processor of the MLD may be configured to provide, via the transceiver, a transmit wake time (TWT) request message to establish a TWT agreement. The MLD may receive, via the transceiver, a TWT response message comprising an indication that the TWT agreement is accepted. The MLD may be configured to communicate, via the transceiver, on the plurality of links in accordance with the TWT agreement. The TWT agreement may establish at least one trigger-enabled TWT service period (SP), during which communications may occur. The MLD may be in a doze state when not in a TWT SP.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is an example design of a multi-Multi-Link-Device (MMLD) element;

FIG. 3 is another example design of an MMLD element;

FIG. 4 is another example design of an MMLD element;

FIG. 5 is another example design of an MMLD element;

FIG. 6 is an example design of a multi-link element with MMLD information or a MMLD variant of a multi-link element;

FIG. 7 is an example illustration of individual Target wake time (TWT) operation in Multi-MLD environments; and

FIG. 8 is another example illustration of individual TWT operation in Multi-MLD environments.

FIG. 9 is an architectural diagram illustrating various MLD APs.

FIG. 10 depicts an example flow diagram summarizing a high-level process for performing multi-link operations.

### DETAILED DESCRIPTION

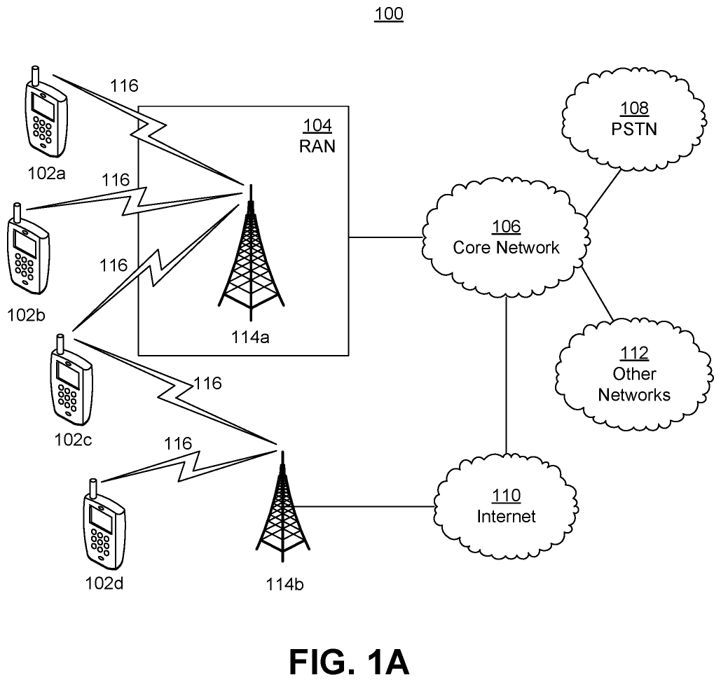

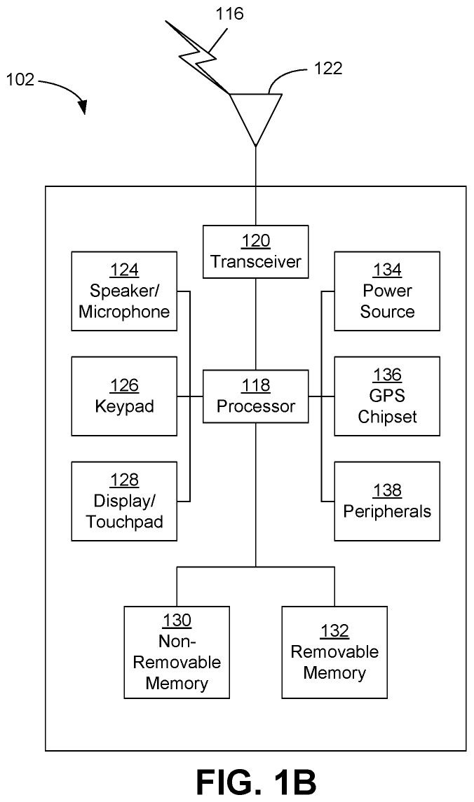

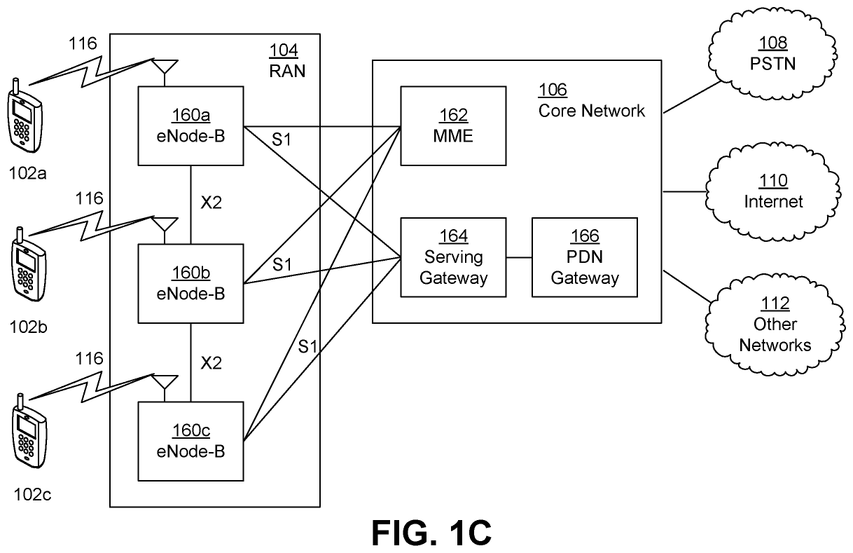

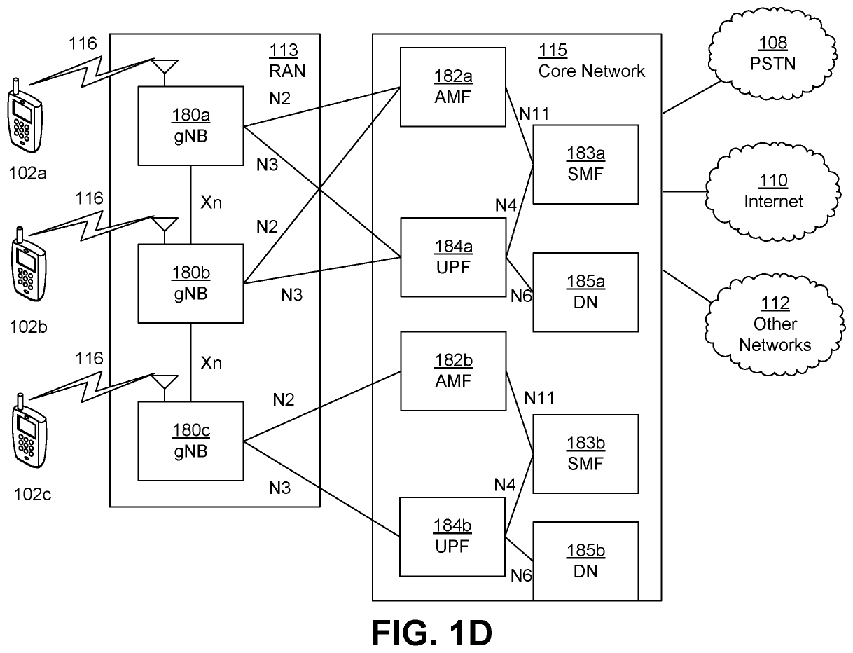

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHZ, and 20 MHz bandwidths in the TV White Space (TVWS) spectrum, and 802.11ah supports 1 MHZ, 2 MHZ, 4 MHZ, 8 MHZ, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHZ, 8 MHZ, 16 MHZ, and/or other channel bandwidth operating modes. Carrier sensing and/or Network

Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WLAN in Infrastructure BSS mode may have an AP for the BSS and one or more STAs associated with the AP. The AP may have access or interface to a Distribution System (DS) or another type of wired/wireless network that may carry traffic in and out of the BSS. Traffic to STAs that originates from outside the BSS may arrive through the AP and may be delivered to the STAs. Traffic originating from STAs to destinations outside the BSS may be sent to the AP to be delivered to the respective destinations. Traffic between STAs within the BSS also may be sent through the AP where the source STA may send traffic to the AP and the AP may deliver the traffic to the destination STA. Such traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

Using the 802.11ac infrastructure mode of operation, the AP may transmit a beacon on a fixed channel, such as the primary channel, for example. This channel may be 20 MHz wide, and may be the operating channel of the BSS. This channel also may be used by the STAs to establish a connection with the AP. The fundamental channel access mechanism in an 802.11 system may be Carrier Sense Multiple Access with Collision Avoidance (CSMA/CA). In this mode of operation, every STA, including the AP, may sense the primary channel. If the channel is detected to be busy, the STA may back off. Hence, in an example embodiment, one STA may transmit at any given time in a given BSS.

In 802.11n, High Throughput (HT) STAs also may use a 40 MHz wide channel for communication. This may be achieved by combining the primary 20 MHz channel, with an adjacent 20 MHz channel to form a 40 MHz wide contiguous channel.

In 802.11ac, Very High Throughput (VHT) STAs may support 20 MHz, 40 MHZ, 80 MHZ, and 160 MHz wide channels. The 40 MHZ, and 80 MHZ, channels may be formed by combining contiguous 20 MHz channels similar to 802.11n described above. A 160 MHz channel may be formed either by combining 8 contiguous 20 MHz channels, or by combining two non-contiguous 80 MHz channels, this also may be referred to as an 80+80 configuration. For the 80+80 configuration, the data, after channel encoding, is passed through a segment parser that divides it into two streams. IFFT, and time domain, processing may be accomplished on each stream separately. The streams are then mapped on to the two channels, and the data is transmitted. At the receiver, this mechanism is reversed, and the combined data is sent to the MAC.

Use cases and applications of 802.11 Extremely High Throughput (EHT) may include Video-over-WLAN, Augmented Reality (AR), Virtual Reality (VR), or the like. Features that may be achievable via increased peak throughput and improved efficiency may include Multi-AP, Multi-Band/multi-link, 320 MHz bandwidth, 16 Spatial streams, HARQ, Full Duplex (in time and frequency domain), AP Coordination, Semi-Orthogonal Multiple Access (SOMA), designs proposed for 6 GHz channel access, or the like. Further, coordinated Multi-AP (C-MAP) transmissions will be supported in 802.11be. Applicable schemes may include Coordinated Multi-AP OFDMA (co-OFDMA), Coordinated Multi-AP TDMA (co-TDMA), Coordinated Multi-AP Spatial Reuse (CSR), Coordinated beamforming/nulling (CBF), Joint Transmission (JTX), or the like.

In the context of coordinated Multi-AP, as described herein, a sharing AP refers to an EHT AP that obtains a transmit opportunity (TXOP) and initiates the multi-AP coordination. A shared AP refers to an EHT AP which is coordinated for the multi-AP transmission by the sharing AP. An AP candidate set refers to a set of APs that may initiate or participate in multi-AP coordination.

Methods, apparatuses, and systems for the discovery of Multiple AP/STA Multi-Link-Device (MLD) sets are described herein. A mechanism may be defined to determine whether an AP is part of an AP candidate set and if the AP may participate as a shared AP in coordinated AP transmission initiated by a sharing AP. A process may be defined for an AP to share its frequency/time resources of an obtained TXOP with a set of APs. An AP that intends to use the resource (e.g., frequency or time) shared by another AP may be able to indicate its resource needs to the AP that shared the resource. Coordinated OFDMA may supported, and in a coordinated OFDMA, both DL OFDMA and its corresponding UL OFDMA acknowledgement may be allowed.

Multiple AP MLDs may be configured to provide coordinated operations over an area to achieve enhanced throughput and user experience for STAs and STA MLDs (also referred to as non-AP MLDs). In order to benefit from the enhanced throughput and performance, STAs and STA MLDs may be informed of the presence of the coordinated Multiple AP MLD set as well as the coordinated operations that the set provides. The multiple AP MLD sets may be informed of the capabilities of the STA or STA MLDs. Described herein is an efficient discovery procedure for STA and STA MLDs as well as for multiple AP MLD sets.

Embodiments pertaining to Multiple AP/STA MLD Architecture are described herein. These embodiments may relate to a Multi-AP MLD Management entity, a BSS, extended service set (ESS) etc. For a set of MLD APs to work together to provide network services to non-AP MLDs the MLD APs may be configured/set-up to coordinate the transmissions of frames in such a manner that the non-AP MLD may receive the frames. Also, transmissions by the non-AP MLDs may be able to be received and combined by these configured/setup MLD APs. Therefore, it is advantageous that the MLD APs acting as multi-MLD APs and the non-AP MLDs associated with them have a known architecture, means of exchanging frames, and means of providing network services. Currently, there is no multi-MLD architecture or defined configuration.

Embodiments pertaining to Multiple MLD Target wake time (TWT) Operation are described herein. When a set of MLD APs coordinate within TWT Service Period (SP), it may require that cooperating APs have TWT information of sharing AP such that these APs or subset of APs may coordinate smoothly in different operational links. Currently, there is no such procedure to define how cooperating APs may exchange TWT information on multi-link, how they serve the STAs jointly, and how the sharing AP may help its associated STAs and OBSS STAs simultaneously, etc.

A MMLD may comprise multiple APs, or STAs. Each of the APs or STAs may be part of a physical device, which may be an MLD which may comprise one or more APs or STAs. Each of the MLDs may be located in the same physical location or different physical locations.

An AP Multi-MLD is a MMLD of which the STAs affiliated with the MMLD may be APs. In an example, an AP MMLD is a MMLD in which each MLD affiliated with the MMLD is an AP MLD. A non-AP Multi-MLD is a MMLD in which the STAs affiliated with the MMLD may be non-AP STAs. In an example, a non-AP MMLD is a MMLD in which each of the MLDs affiliated with the MMLD is a non-AP MLD. A mixed STA Multi-MLD is a MMLD of which some of the STAs affiliated with the MMLD may be APs while some of the STAs affiliated with the MMLD may be non-AP STAs.

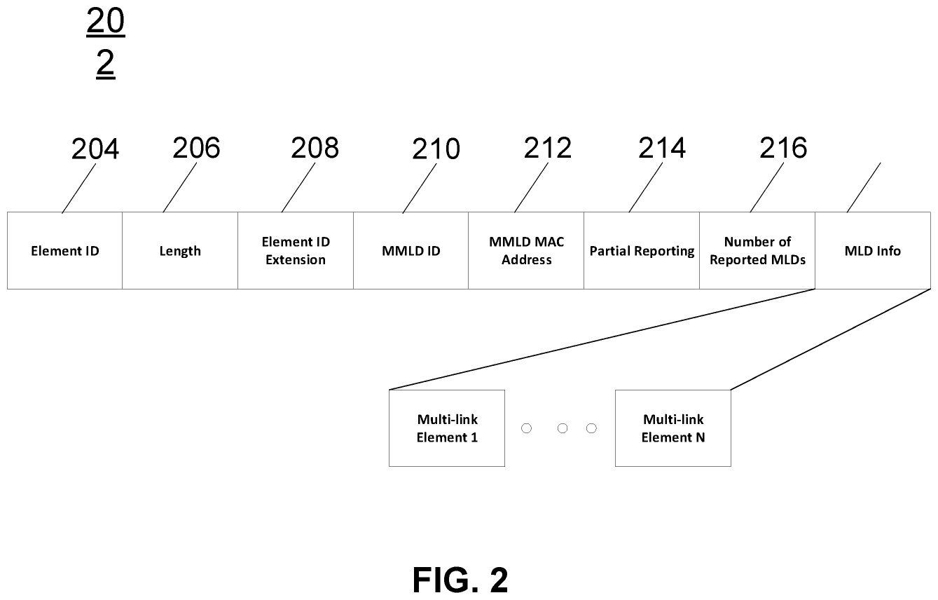

In one example, an AP that is affiliated with an MLD that is a part of an MMLD and may include a MMLD element in frames that it transmits, such as beacon, short beacon, probe responses, fast initial link setup (FILS) discovery frames, association responses, etc., to indicate that it is part of an MLD that is a part of a MMLD and to provide information of one or more MLDs or APs that are affiliated with the same MMLD. An example design of such a Multi-AP element or MMLD element is depicted in FIG. 2.

FIG. 2 depicts an example design of an MMLD element 202. MMLD element 202 may contain some or all of the following fields or subfields: Element ID 204, length 206, Element ID Extension 208, MMLD ID 210, MMLD MAC Address 212, Partial Reporting 214, Number of Reported MLDs 216, and/or an MLD info field 218.

Element ID field 204 and/or Element ID Extension field 208 may indicate that element 202 is an MMLD element. Length field 206 may indicate the length of MMLD element 202. MMLD ID field 210 may indicate the MMLD ID. The MMLD ID may be one octet in length; the MMLD ID may identify the ID of the MMLD that the transmitting AP is affiliated with, or indicate that the MLD with which the transmitting AP is affiliated with is a part of the MMLD. MMLD MAC Address field 212 may indicate the MMLD MAC Address. MMLD MAC Address field 212 may be six octets in length. The MMLD MAC Address may identify the ID of the MMLD that the transmitting AP is affiliated with, or indicate that the MLD with which the transmitting AP is affiliated with is a part of the MMLD. The MMLD MAC Address may be a multicast address the MLDs or APs that are affiliated with the MMLD may filter on the DS. Partial Reporting field 214 may indicate whether all or a subset of the APs or MLDs that are affiliated with the MMLD are being reported in MMLD element 202. In one example, Partial Reporting field 214 may indicate whether all APs and/or MLDs that are affiliated with the MMLD are being reported in MMLD element 202. Partial Reporting field 214 also may indicate that a subset of APs and/or MLDs that are affiliated with the MMLD are being reported in MMLD element 202. In another example, Partial Reporting field 214 may indicate that the direct neighboring APs and/or MLDs of the reporting AP and/or MLD that are affiliated with the same MMLD are being reported. In yet another example, Partial Reporting field 214 may indicate that the direct neighboring APs and/or MLDs of the reporting AP and/or MLD that may be affiliated with the same MMLD or different MMLDs are being reported. Number of Reported MLDs field 216 may indicate the number of reported MLDs. E.g., this number may indicate the number of subfields that is contained in MLD Info field 218. MLD info field 218 may contain one or more info subfield, each of which may contain the information that is associated with a report MLD. In one example, the information of each reported MLD may be provided using a Multi-link element (depicted in FIG. 2). Each multi-link element may report the MLD ID, MLD MAC Address, and/or one or more APs that are affiliated with the MLD and the operating parameters for these MLD and APs. The multi-link elements may be of the existing format or enhanced design to report additional MLDs that are affiliated with an MMLD. In another example, the multi-link element may be of the MMLD variant.

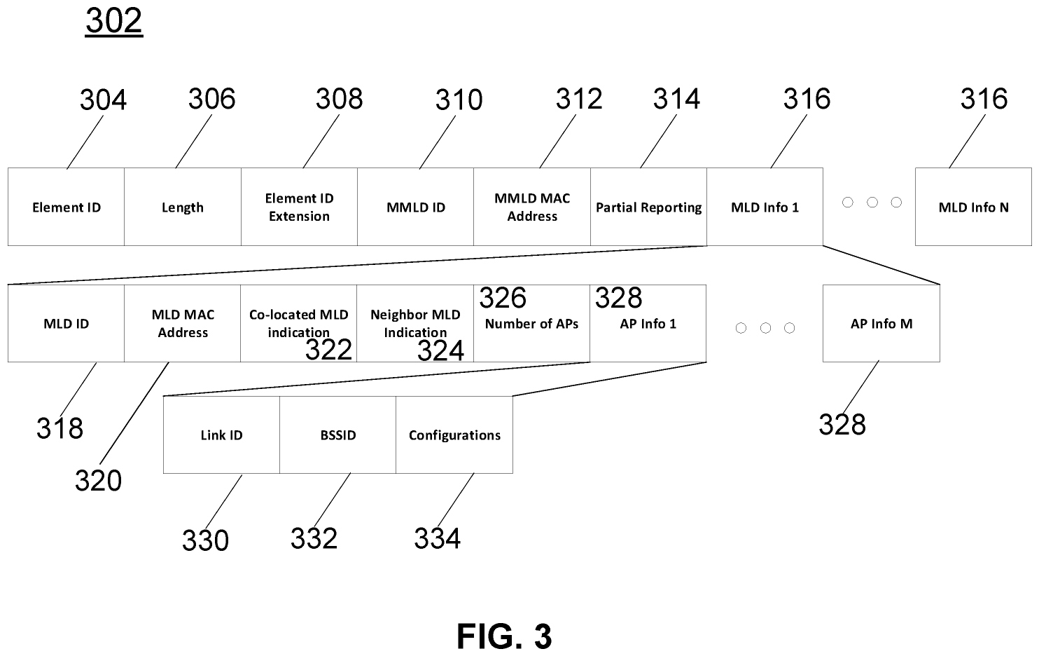

FIG. 3 depicts another example design of an MMLD element 302. In this example, MMLD element 302 may contain some or all of the following fields or subfields: Element ID 304, Element ID Extension 308, Length 306, MMLD ID 310, MMLD MAC Address 312, Partial Reporting 314, MLD info field n 316 for n=1, . . . , N MLDs.

Element ID field 304 and/or Element ID Extension field 308 may indicate that element 302 is an MMLD element. In an example embodiment, a value in an element ID may indicate that there is an element ID extension subfield. Thus, an additional field may be added to accommodate more values. Length subfield 306 may indicate the length of MMLD element 302. MMLD ID field 310 may indicate the MMLD ID. The MMLD ID may be one octet in length; the MMLD ID may identify the ID of the MMLD that the transmitting AP is affiliated with, or indicate that the MLD with which the transmitting AP is affiliated with is a part of the MMLD. MMLD MAC Address field 312 may indicate the MMLD MAC Address. MMLD MAC Address field 312 may be six octets in length. The MMLD MAC Address may identify the ID of the MMLD that the transmitting AP is affiliated with, or indicate that the MLD with which the transmitting AP is affiliated with is a part of the MMLD. The MMLD MAC Address may be a multicast address the MLDs or APs that are affiliated with the MMLD may filter on the DS. Partial Reporting field 314 may indicate whether all or a subset of the APs or MLDs that are affiliated with the MMLD are being reported in MMLD element 302. In one example, Partial Reporting field 314 may indicate whether all APs and/or MLDs that are affiliated with the MMLD are being reported in the MMLD element. Partial Reporting field 314 also may indicate that a subset of APs and/or MLDs that are affiliated with the MMLD are being reported in MMLD element 302. In another example, Partial Reporting field 314 may indicate that the direct neighboring APs and/or MLDs of the reporting AP and/or MLD that are affiliated with the same MMLD are being reported. In yet another example, Partial Reporting field 314 may indicate that the direct neighboring APs and/or MLDs of the reporting AP and/or MLD that may be affiliated with the same MMLD or different MMLDs are being reported. MLD info field 316 n for n=1, . . . , N MLDs: each of the MLD info field may contain information on one MLD.

Each MLD Info field 316 may contain some or all of the following subfields: MLD ID 318, MLD MAC Address 320, Co-located MLD indication 322, Neighbor MLD indication 324, Number of Aps 326, AP Info subfields 1−N 328. MLD ID subfield 318 may indicate the MLD ID of the MLD that is affiliated with the MMLD. If multi-link is activated, a STA may be affiliated with a MMLD. The MLD ID may be one octet in length; the MLD ID may identify the ID of the reported MLD. MLD MAC Address subfield 320 may indicate the MAC address of the reported MLD. Co-located MLD indication subfield 322 may indicate whether the reported MLD is co-located with the MLD with which the transmitting AP is affiliated with. Neighbor MLD Indication subfield 324 may indicate whether the reported MLD is a neighbor MLD to the MLD of which the transmitting AP is affiliated with. In one example, Neighbor MLD Indication subfield 324 may indicate a value which means that the reported MLD is a direct neighbor MLD, e.g., within radio range or in the direct vicinity of the MLD with which the transmitting AP is affiliated with. Number of APs subfield 326 may indicate the number of APs that are affiliated with the reported MLD. Each one of the AP Info subfields 1−N 328 may indicate the information about an AP that is affiliated with the reported MLD.

Each AP info subfield 328 may contain one or more subfields, such as, for example, Link ID subfield 330, basic service set identifier (BSSID) subfield 332, configurations subfield 334, or the like, or any appropriate combination thereof. Link ID subfield 330 may indicate the ID of the link and may be 4 bits in length and may be associated with the link on which the reported AP is operating. BSSID subfield 332 may include the BSSID of the reported AP. Configurations subfield 334 may indicate one or more operating parameters for the reported AP, such as operating channel, basic service set (BSS) Color, or other type of parameters.

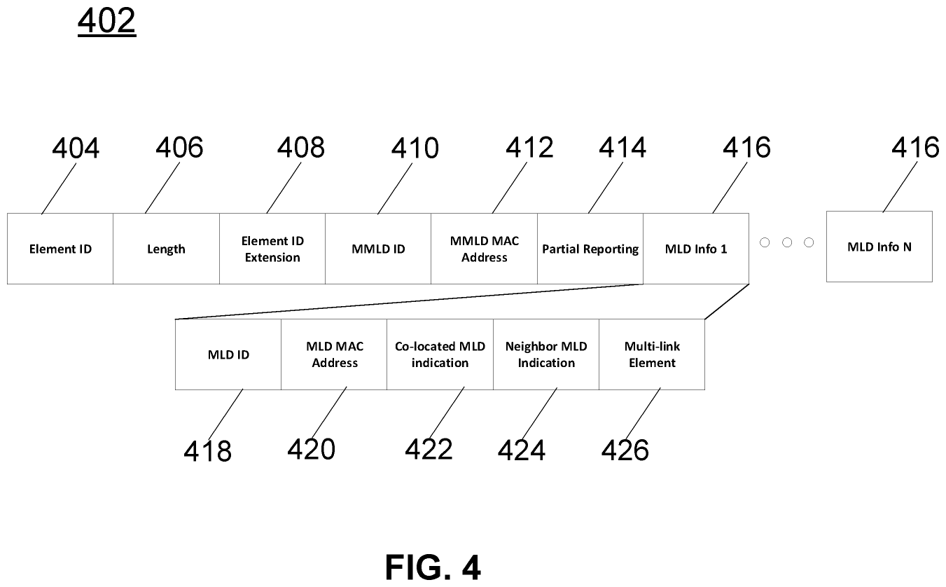

FIG. 4 depicts another example design of an MMLD element 402. In this example, the MMLD element may contain some or all of the following fields: Element ID 404 and Element ID Extension 408, Length 406, MMLD ID 410, MMLD MAC Address 412, Partial Reporting 414, and/or MLD info field n, for n=1, . . . , N 416. Element ID field 404 and Element ID Extension field 408 may indicate that element 402 is an MMLD element. Length subfield 406 may indicate the length of MMLD element 402. MMLD ID field 410 may indicate the MMLD ID. The MMLD ID may be one octet in length; the MMLD ID may identify the ID of the MMLD that the transmitting AP is affiliated with, or indicate that the MLD with which the transmitting AP is affiliated with is a part of the MMLD. MMLD MAC Address field 412 may indicate the MMLD MAC Address. MMLD MAC Address field 412 may be six octets in length. The MMLD MAC Address 412 may identify the ID of the MMLD that the transmitting AP is affiliated with, or indicate that the MLD with which the transmitting AP is affiliated with is a part of the MMLD. The MMLD MAC Address 412 may be a multicast address the MLDs or APs that are affiliated with the MMLD may filter on the DS. Partial Reporting field 414 may indicate whether all or a subset of the APs or MLDs that are affiliated with the MMLD are being reported in the MMLD element. In one example, Partial Reporting field 414 may indicate whether all APs and/or MLDs that are affiliated with the MMLD are being reported in the MMLD element. Partial Reporting field 414 also may indicate that a subset of APs and/or MLDs that are affiliated with the MMLD are being reported in the MMLD element. In another example, Partial Reporting field 414 may indicate that the direct neighboring APs and/or MLDs of the reporting AP and/or MLD that are affiliated with the same MMLD are being reported. In yet another example, Partial Reporting field 414 may indicate that the direct neighboring APs and/or MLDs of the reporting AP and/or MLD that may be affiliated with the same MMLD or different MMLDs are being reported. Each field of MLD info field 416 may contain information on one MLD.

Each of the MLD Info field 416 may contain some or all of the following subfields: MLD ID 418, MLD MAC Address 420, Co-located MLD indication 422, Neighbor MLD indication 424, and/or Multi-link element 426.

MLD ID subfield 418 may indicate the MLD ID of the MLD that is affiliated with the MMLD. The MLD ID may be one octet in length; the MLD ID may identify the ID of the reported MLD. MLD MAC Address subfield 420 may indicate the MAC address of the reported MLD. Co-located MLD indication subfield 422 may indicate whether the reported MLD is co-located with the MLD with which the transmitting AP is affiliated with. Neighbor MLD Indication subfield 424 may indicate whether the reported MLD is a neighbor MLD to the MLD of which the transmitting AP is affiliated with. In one example, Neighbor MLD Indication subfield 424 may indicate a value which means that the reported MLD is a direct neighbor MLD, e.g., within radio range or in the direct vicinity of the MLD with which the transmitting AP is affiliated with. Multi-link element field 426 may be used to report on the details on the reported MLD that is identified by the MLD ID or MLD MAC address that is contained in the same MLD Info field. A multi-link element may report the MLD ID, MLD MAC Address, and one or more APs that are affiliated with the MLD and the operating parameters for these MLD and APs. The multi-link elements may be of the existing format such as basic variant or probe request variant, or enhanced design to report additional MLDs that are affiliated with an MMLD. In another example, the multi-link element may be of the MMLD variant.

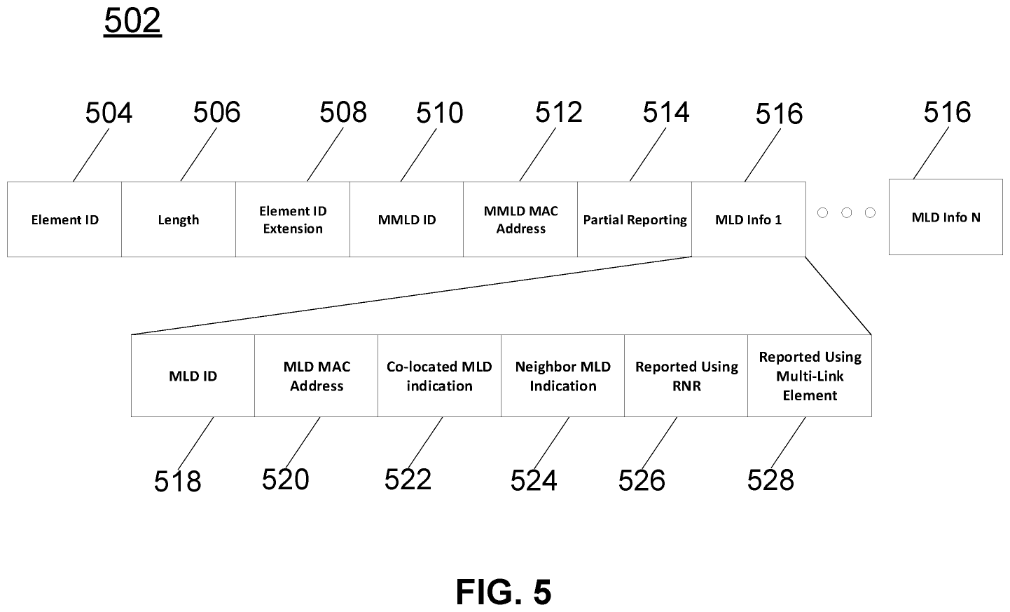

FIG. 5 depicts another example design of an MMLD element 502. In this example, MMLD element 502 may contain some or all of the following fields: Element ID 504, Element ID Extension 508, Length 506, MMLD ID 510, MMLD MAC Address 512, Partial Reporting 514, and/or MLD info field n, for n=1, . . . , N 516.

Element ID field 504 and Element ID Extension filed 508 may indicate that element 502 is an MMLD element. Length subfield 506 may indicate the length of MMLD element 502. MMLD ID field 510 may indicate the MMLD ID. The MMLD ID may be one octet in length; the MMLD ID may identify the ID of the MMLD that the transmitting AP is affiliated with, or indicate that the MLD with which the transmitting AP is affiliated with is a part of the MMLD. MMLD MAC Address field 512 may indicate the MMLD MAC Address. The MMLD MAC Address field 512 may be six octets in length. The MMLD MAC Address may identify the ID of the MMLD that the transmitting AP is affiliated with, or indicate that the MLD with which the transmitting AP is affiliated with is a part of the MMLD. The MMLD MAC Address may be a multicast address the MLDs or APs that are affiliated with the MMLD may filter on the distributed system (DS).

The Partial Reporting field 514 may indicate whether all or a just a subset of the APs or MLDs that are affiliated with the MMLD are being reported in the MMLD element. In one example, Partial Reporting field 514 may indicate whether all APs and/or MLDs that are affiliated with the MMLD are being reported in the MMLD element. Partial Reporting field 514 may also indicate that a subset of APs and/or MLDs that are affiliated with the MMLD are being reported in the MMLD element. In another example, Partial Reporting field 514 may indicate that the direct neighboring APs and/or MLDs of the reporting AP and/or MLD that are affiliated with the same MMLD are being reported. In yet another example, Partial Reporting field 514 may indicate that the direct neighboring APs and/or MLDs of the reporting AP and/or MLD that may be affiliated with the same MMLD or different MMLDs are being reported.

Each of MLD info field 516 may contain information on one MLD. Each of the MLD Info field 516 may contain some or all of the following subfields: MLD ID field 518, MLD MAC address field 520, Co-located MLD indication field 522, Neighbor MLD Indication field 524, Reported Using RNR element field 526, Reported using Multi-link element field 528, or the like, or any appropriate combination thereof.

MLD ID subfield 518 may indicate the MLD ID of the MLD that is affiliated with the MMLD. MLD ID field 518 may be one octet in length. MLD ID field 518 may identify the ID of the reported MLD. MLD MAC Address subfield 520 may indicate the MAC address of the reported MLD. Co-located MLD indication subfield 522 may indicate whether the reported MLD is co-located with the MLD with which the transmitting AP is affiliated with. Neighbor MLD Indication subfield 524 may indicate whether the reported MLD is a neighbor MLD to the MLD of which the transmitting AP is affiliated with. In one example, Neighbor MLD Indication subfield 524 may indicate a value which means that the reported MLD is a direct neighbor MLD, e.g., within radio range or in the direct vicinity of the MLD with which the transmitting AP is affiliated with. Reported Using RNR element subfield 526 may indicate that that the details of the reported MLD or AP may be provided using a Reduced Neighbor Report (RNR) element, which may be contained in the same frame, and/or transmitted in frames by the same AP, or transmitted by APs affiliated with the same MLD, or by MLDs that are affiliated with the same MMLD. E.g., using the MLD ID, and/or MLD MAC address, a receiving STA may obtain information from a multi-link element on the reported MLD and/or AP that may be affiliated with the reported MMLD. Reported using Multi-link element subfield 528 may indicate that the details of the reported MLD or AP may be provided using Multi-link element, which may be contained in the same frame, and/or transmitted by the same AP, or transmitted in frames by APs affiliated with the same MLD, or by MLDs that are affiliated with the same MMLD. E.g., using the MLD ID, and/or MLD MAC address, a receiving STA may obtain information from a multi-link element on the reported MLD and/or AP that may be affiliated with the reported MMLD.

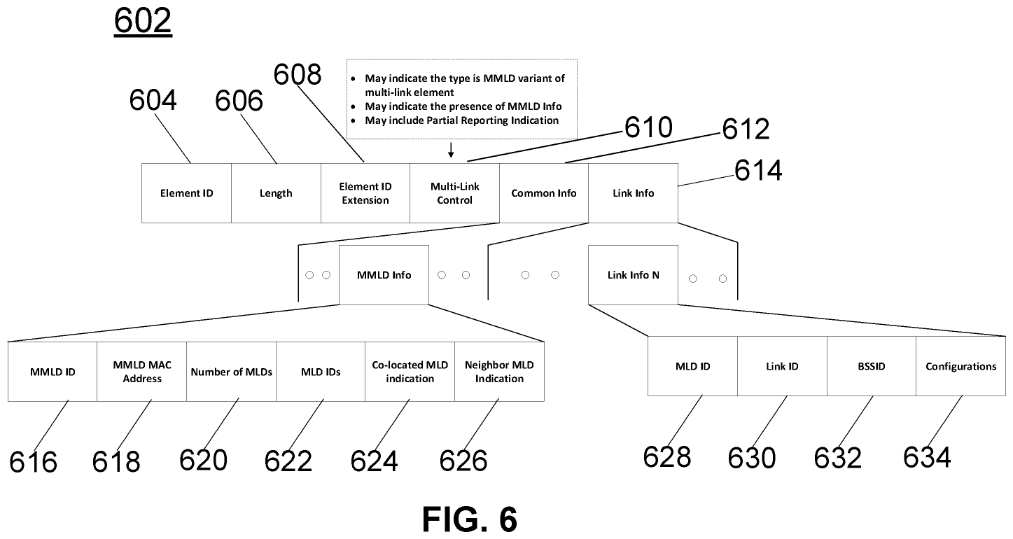

In one example, an AP that is affiliated with an MLD that is a part of an MMLD may include a multi-link element in a frame that it is transmitting to advertise all or a subset of the APs that are affiliated with the MMLD. Such frames may include beacon, short frame, FILS discovery frame, authentication request frame, association request frame, etc. An example design of the multi-link element 602 to indicate the MMLD is depicted in FIG. 6.

FIG. 6 depicts an example design of a multi-link element 602 with MMLD information or a MMLD variant of a multi-link element. Multi-link element 602 with MMLD information may contain some or all of the following fields. Element ID 604, Element ID Extension 608, which may be combined with Element ID 604 to indicate that the element is a multi-link element. In another example, Element ID 604 and Element ID Extension 608 may be combined to indicate that element 602 is a MMLD multi-link element. Length subfield 606 may indicate the length of the element. There may be information contained in element 602 that may indicate that the element may be fragmented. There may be information indicating multi-link element ID 604 and fragmentation number of the multi-link element. Multi-link Control field 610 may indicate various information about MMLD multi-link element or MMLD variant of multi-link ID 602, which may include some or all of the following. A type field may indicate that the multi-link element is an MMLD variant of multi-link element. The type field may be a subfield of Multi-Link Control field 610 (not shown in FIG. 6). The type indicating that the multi-link element is an MMLD variant of multi-link element may imply that MMLD Info is included in the MMLD variant of multi-link element, e.g., in Common Info field 612. A Presence of MMLD Info subfield (not shown in FIG. 6) may indicate that MMLD Info may be included in the Common Info or any other parts of the MMLD variant of multi-link element or in the multi-link element. A Partial Reporting Indication field (not shown in FIG. 6) may indicate whether all or a just a subset of the APs or MLDs that are affiliated with the MMLD are being reported in the current element. In one example, this indication may indicate whether all APs and/or MLDs that are affiliated with the MMLD are being reported in the current element; this indication may also indicate that only a subset of APs and/or MLDs that are affiliated with the MMLD are being reported in the current element. In another example, this indication may indicate that only the direct neighboring APs and/or MLDs of the reporting AP and/or MLD that are affiliated with the same MMLD are being reported. In yet another example, this indication may indicate that only the direct neighboring APs and/or MLDs of the reporting AP and/or MLD that may be affiliated with the same MMLD or different MMLDs are being reported. Common Info field 612 may indicate the MMLD Info, which may include some or all of the following subfields. MMLD ID field 616 may indicate the MMLD ID. The MMLD ID may be one octet in length; the MMLD ID may identify the ID of the MMLD that the transmitting AP is affiliated with, or indicate that the MLD with which the transmitting AP is affiliated with is a part of the MMLD. MMLD MAC Address field 618 may indicate the MMLD MAC Address. The MMLD MAC Address field 618 may be six octets in length. MMLD MAC Address field 618 may indicate the MAC address of the reported MLD. The MMLD MAC Address may be a multicast address of the MLDs or APs that are affiliated with the MMLD may filter on the DS. Partial Reporting field (not shown in FIG. 6) may indicate whether all or a just a subset of the APs or MLDs that are affiliated with the MMLD are being reported in the MMLD element. In one example, this field may indicate whether all APs and/or MLDs that are affiliated with the MMLD are being reported in the MMLD element; this field may also indicate that a subset of APs and/or MLDs that are affiliated with the MMLD are being reported in the MMLD element. In another example, this field may indicate that the direct neighboring APs and/or MLDs of the reporting AP and/or MLD that are affiliated with the same MMLD are being reported. In yet another example, this field may indicate that the direct neighboring APs and/or MLDs of the reporting AP and/or MLD that may be affiliated with the same MMLD or different MMLDs are being reported. Number of MLDs subfield 620 may indicate the number of MLDs that are affiliated with the MMLD. MLD IDs subfield 622 may include the MLD IDs that are affiliated with the MMLD. The MLD IDs may be implemented as a list of maps, or a bitmap to indicate one or more MLD IDs that are affiliated with the MMLD. Co-located MLD Indication subfield 624 may indicate one or more IDs of MLDs that are co-located with the transmitting MLD or with the MLD with which the transmitting AP is affiliated. Neighbor MLD Indication subfield 626 may indicate one or more IDs of MLDs that are neighbors to the transmitting MLD or to the MLD with which the transmitting AP is affiliated. Link Info field 614 may include one or more Link Info N field with each of the Link Info N field indicating the information of a particular AP that may be affiliated with the same MMLD.

Each of the Link Info N subfield may include some or all of the following subfields. MLD ID subfield 628 may indicate the ID of the reported MLD with which the AP on the reported Link is affiliated. An MLD MAC Address subfield (not shown in FIG. 6) may indicate the MAC address of the reported MLD with which the AP on the reported link is affiliated. A Co-located MLD indication subfield may indicate whether the reported MLD indicated by MLD ID is co-located with the MLD with which the transmitting AP is affiliated with. Alternatively, this information may also be obtained from the indication in the MMLD Info and based on the MLD ID and/or MLD MAC Address. A Neighbor MLD Indication subfield may indicate whether the reported MLD indicated by MLD ID is a neighbor MLD to the MLD of which the transmitting AP is affiliated with. In one example, this subfield may indicate a value which means that the reported MLD is a direct neighbor MLD, e.g., within radio range or in the direct vicinity of the MLD with which the transmitting AP is affiliated with. Alternatively, this information may also be obtained from the indication in the MMLD Info and based on the MLD ID and/or MLD MAC Address. Link ID subfield 630 may indicate the ID of the link and may be 4 bits in length and may be associated with the link on which the reported AP is operating. Basic service set identifier (BSSID) subfield 632 may include the BSSID of the reported AP. Configurations subfield 634 may indicate one or more operating parameters for the reported AP, such as operating channel, BSS Color, or other type of parameters.

In an example MMLD Discovery procedure, an AP that is affiliated with an MLD that is affiliated with an MMLD may include one or more MMLD elements and/or an multi-link elements and/or an MMLD variant of multi-link elements in frames that it transmits, such as beacon, short beacon, probe response, (re)association response or other type of frames, to indicate that it is affiliated with an MMLD, and/or to indicate one or more MMLDs. In another example, an AP that is affiliated with a MMLD may include one or more MMLD elements and/or multi-link elements and/or an MMLD variant of multi-link elements in frames that it transmits, such as beacon, short beacon, probe response, (re)association response or other type of frames, to indicate that it is affiliated with an MMLD, and/or to indicate one or more MMLDs.

In one example, the AP or MLD may include a subset of information of the MMLD in its beacon or regular probe responses or other type of frames, which may include one or more of the following: MMLD ID, MMLD MAC Address, and limited information of one or more MLDs such as their MLD IDs, MLD MAC Addresses. A special MLD ID and/or MLD MAC Address may identify the transmitting MLD and/or the MLD with which the transmitting AP is affiliated. The AP or MLD may also include more detailed information on the MLDs in other elements, such as multi-link elements, or Reduced Neighbor Report (RNR) element. Based on the information included in the MMLD element and/or multi-link element on MLDs, such as MMLD MAC address, MMLD ID, MLD ID, or MLD MAC Address, and/or Neighbor MLD Indication, and/or Co-located MLD Indication, a receiving STA may be able to discover the APs that are associated with the MLDs that are affiliated with the same MMLD as the transmitting MLD or the with the MLD with which the transmitting AP is affiliated, and/or affiliated an MLD that is affiliated with the same MMLD, and/or affiliated with a co-located MLD with the transmitting MLD or with the MLD with which the transmitting AP is affiliated, and/or affiliated with an MLD that is a neighbor MLD to the transmitting MLD or the with the MLD with which the transmitting AP is affiliated, and/or an AP that may be affiliated with a different MMLD.

If a special MLD ID, or MLD MAC Address is utilized to indicate the MLD with which the transmitting AP is affiliated, a receiving STA may identify the APs that are affiliated with the same MLD as the transmitting AP based on the special MLD ID and/or MLD MAC Address.

In another example, an AP may include a multi-link element to indicate the MLD with which it is affiliated, and additionally an MMLD element or a MMLD variant of multi-link element to indicate information of the MMLD with which the AP or its MLD is affiliated.

In another example, the AP or MLD may include full information on all the APs/MLDs that are affiliated with the same MMLD with which the transmitting AP is affiliated with. A receiving STA may be able to receive all the information that are associated of all the APs/MLDs that are affiliated with the MMLD. In this case, the AP/MLD may set the Partial Reporting information to false or to indicate complete reporting.

In yet another example, the AP or MLD may include the information on a subset of the APs/MLDs that are affiliated with the same MMLD with which the transmitting AP is affiliated. For example, the subset of APs/MLDs that are direct neighbors to the transmitting AP or its MLD have been reported. In another example, the subset of APs/MLDs that are co-located with the transmitting AP or its MLD have been reported. A receiving STA may be able to receive the information that is associated with the subset of the APs/MLDs that are affiliated with the MMLD, such as co-located APs/MLDs, and/or neighbor APs/MLDs. In this case, the AP/MLD may set the Partial Reporting information to true or set Neighbor MLD indication to true, or co-located MLD indication to true depending on the reported set of APs/MLDs.

A non-AP STA or MLD that is capable of supporting MMLD operation also may include an MMLD element or an MMLD variant of multi-link element in frames it transmits including Probe request, (Re)association request, etc. In another example, a non-AP STA or MLD may include one or more bits indicating of MMLD operation support in its EHT, Ultra High Reliability (UHR), or other capabilities element that it transmits.

A non-AP STA or MLD that is capable of supporting MMLD operations and desires to obtain more information on the MMLD may transmit a probe request that may contain the MMLD element or MMLD variant of multi-link element by following the active scanning procedure for MMLD discovery.

A non-AP STA may transmit a probe request that may contain the MMLD element or MMLD variant of a multi-link element, which may be a Multi-link probe request or MMLD probe request. A multi-link or MMLD probe request may be referred to as probe request herein.

The Probe Request may be transmitted to a broadcast address, or may be transmitted to a particular BSSID of an AP, which may have advertised that it is affiliated with an MLD that is affiliated with an MMLD by including a MMLD element, and/or MMLD variant of multi-link element, and/or RNR element, and/or multi-link element, or may be transmitted to an MMLD MAC address.

The Probe Request frame may contain a MMLD element and/or MMLD variant of multi-link element and/or a multi-link element which may contain one or more MMLD IDs and/or one or more MMLD MAC addresses of the MMLDs the probing STA/MLD desires additional information. If only a submit of MLDs of a MMLD is desired, the MMLD element, multi-link element etc. may contain a list of identifiers of MLDs, such as MLD IDs, to indicate that only the information of MLDs indicated is desired.

The Probe Request frame may contain an MMLD element and/or MMLD variant of multi-link element and/or a multi-link element which may contain an indication whether the probing STA/MLD desires complete information of the MMLD, or partial reporting of the MMLDs, such as co-located MLDs, neighbor MLDs, may be desired.

An AP/MLD which is affiliated with an MMLD may respond to a received MMLD probe request. For example, the AP/MLD affiliated with a MMLD may respond with a probe response frame, which may contain a MMLD element and/or multi-link element, and/or an MMLD variant of multi-link, and/or with RNR element, If the received probe request is addressed to a broadcast address, and the MMLD element or multi-link element contained in the probe request frame is set to a wild card MMLD ID, and/or MMLD MAC Address is set to a wild card MMLD MAC Address.

The AP/MLD affiliated with a MMLD may respond with a probe response frame, which may contain a MMLD element and/or multi-link element, and/or a MMLD variant of multi-link, and/or with RNR element. If the received probe request is addressed to its MAC address, and the MMLD element or multi-link element contained in the probe request frame is set to a wild card MMLD ID, and/or to the MMLD ID of the MMLD to which the AP/MLD is affiliated, and/or a MMLD MAC address that may be a wild card MMLD MAC Address, and/or the MMLD MAC address of the MMLD ID of the MMLD to which the AP/MLD is affiliated.

The AP/MLD affiliated with a MMLD may respond with a probe response frame, which may contain an MMLD element and/or multi-link element, and/or an MMLD variant of multi-link, and/or with RNR element. If the received probe request is addressed to the MMLD MAC address of the MMLD with which the AP/MLD is affiliated, and/or the MMLD element or multi-link element contained in the probe request frame is set to a wild card MMLD ID, and/or to the MMLD ID of the MMLD to which the AP/MLD is affiliated, and/or a MMLD MAC address that may be a wild card MMLD MAC Address, and/or the MMLD MAC address of the MMLD ID of the MMLD to which the AP/MLD is affiliated.

The AP/MLD affiliated with a MMLD may provide information on all MLDs and/or APs that are affiliated with the MMLD in the probe response frames if a list of MLD IDs or MLD MAC Addresses are included in the received Probe Request frame, provided that one or more other conditions of responding are satisfied.

The AP/MLD affiliated with a MMLD may provide information on a subset of MLDs and/or APs that are affiliated with the MMLD in the probe response frames if a list of MLD IDs or MLD MAC Addresses are included in the received Probe Request frame, provided that one or more other conditions of responding are satisfied.

The AP/MLD affiliated with a MMLD may provide information on a subset of MLDs and/or APs that are affiliated with the MMLD in the probe response frames, for example, if Neighbor MLDs and/or Co-located MLDs as the transmitting MLD or as the MLD with which the responding AP is affiliated if information on only a subset of APs/MLDs are requested in the received Probe Request frame, such as by using partial reporting indication, Co-located MLD indication, neighbor MLD indication, in the MMLD element and/or multi-link element, and/or in the MMLD variant of the multi-link element contained in the received probe request frame, provided that one or more other conditions of responding are satisfied.

In one example, a non-AP STA or MLD may request neighbor MLD information by including some or all of the following indications in its probe request when the probing STA/MLD has mobility or is expected to transition to other BSS soon: MMLD ID, MMLD MAC Address, a list of neighboring MLD ID or MLD MAC address, the Neighbor MLD indication, or the like, and/or any appropriate combination thereof. When receiving such a probe request for neighbor MLD indications, an AP or MLD may respond by transmitting a probe response containing an MMLD element, and/or MMLD variant of MMLD element, and/or multi-link element, providing information on the directly neighboring MLDs that are affiliated with the same or different MMLDs, provided that other responding conditions are satisfied.

A Multiple AP/STA MLD set architecture may comprise a Multi-MLD AP Management Entity. A multi-MLD AP Management Entity may provide coordination and management of the MLD APs that are operating together to provide multi-AP services to non-AP MLDs.

Coordination may include the following aspects: operating frequency of the RF links provided by the MLD APs, synchronization of the transmission of PPDUs on the RF links (for any or all of the following) Joint transmission (PPDUs transmitted by different MLD APs are transmitted so that the receiving non-AP MLD receives the summation of the PPDUs transmitted by the MLD APs), Distributed MIMO transmission (the PPDUs transmitted by different MLD APs are transmitted so that the receiving non-AP MLD receives them as MIMO transmissions that it may combine), and/or MAC level PPDU combining (the PPDUs transmitted by different MLD APs are received as independent PPDUs that may be combined at the MAC layer). Coordination may further include combining received PPDUs from a non-AP MLD received on (any or all of the following): Joint reception, Distributed MIMO reception, MAC level PPDU combining. Coordination may further include the management of security context and keys, management of MAC addresses and transparency of the multi-AP MLD to the non-AP MLD. The receiving non-AP MLD may, or may not be aware that it is receiving PPDUs sent by multiple MLD APs.

In a multi-AP MLD architecture, each affiliated AP may form a BSS for each of its affiliated APs. Affiliated APs that share the same RF link resources (operating channel and bandwidth) may either form a single BSS or have multiple BSSs.

A Multi-MLD AP BSS may have affiliated APs operating as a single BSS. When the affiliated APs that share the same RF link recourses operate as a single BSS it is possible for these affiliated APs to operate transparently and appear as a single affiliated AP to the non-AP MLD. In this configuration to share a single BSS, these affiliated APs may use a common MAC and PHY header and configure themselves so that transmissions to a non-AP MLD are joint transmissions, transmissions that arrive at the non-AP MLD so that they may be received as a single combined frame. Such a received frame may be processed using standard procedures. Alternatively, transmissions may be sent as MIMO transmissions where each of the transmitting antennas of each of the affiliated APs transmits a MIMO encoded transmission. These MIMO encoded transmissions may be received at the non-AP MLD as a MIMO transmission using, for example, standard 802.11 MIMO methods.

A Multi-MLD AP BSS may have affiliated APs operating as independent BSSs. When the affiliated APs share the same RF link resources and operate as independent BSSs these affiliated APs may encode, separated in time, separated in frequency, or any combination of these multiplexing techniques to their transmitted multi-MLD frames. These multiplexing techniques may aid the non-AP MLD in receiving the transmitted frames by reducing interference from the transmission being made by the other affiliated APs that are sharing the RF link resources. The type and nature of multiplexing used by the affiliated APs of the multi-MLD AP may be known by the non-AP MLD to enable the non-AP MLD to receive and combine these transmissions. The non-AP MLD with the knowledge of which transmissions to receive and which multiplexing techniques were used on each of the transmissions may then receive and combine these frames from the affiliated APs.

APs that are affiliated with MLD APs that are part of a multi-MLD AP may utilize the same extended service set (ESS). Being in the same ESS may enable inter-MLD AP communication, non-AP MLD mobility, and RF link sharing. MLD APs may communicate via the DS of the ESS to establish a multi-MLD AP, configure the multi-MLD AP, define multiplexing techniques, define resource sharing (time, frequency, code), coordinate multi-MLD AP beacon content, coordinate frame transmission, coordinate frame reception, and/or maintain security parameters/context for each associated non-AP MLD. Alternatively, any or all of these functions may be accomplished via intra-affiliated AP communication over the wireless medium.

A non-AP MLD associated with a multi-MLD AP may be supported by the ESS differently than a traditional non-AP STA or non-AP MLD. Multi-MLD operation by its nature of having a non-AP MLD associate with multiple MLD APs at the same time, may have some built-in mobility. A non-AP MLD may have services as long as it is in the service area of at least one of the MLD APs in the affiliated multi-AP MLD. Also, multi-MLD operation lends itself to soft transitions, as it is possible for Multi-MLD APs to share an MLD AP(s). This may allow a non-AP MLD to move from one multi-MLD AP to another multi-MLD AP while maintaining some of the resources (affiliated APs) of the first multi-MLD, that are also affiliated with the second multi-MLD.

In multiple MLD TWT operation, a Multiple AP MLD affiliated with the same MMLD may perform coordinated TWT scheduling and operations. Multiple AP MLDs in the MMLD may synchronize with each other. AP MLDs may use timing synchronization function (TSF) to synchronize with each other and also their associated STAs.

In one method, AP MLDs in the MMLD may periodically broadcast their TSF, and/or TSF offsets, for example, in a Beacon frame using timestamp field or other fields/elements. If a receiving AP MLD in the MMLD has a different TSF timer, the AP MLD may adjust its TSF timer to the received timestamp value or report its TSF offset. For example, each AP MLD in the MMLD may broadcast its TSF in the Beacon frame or other type of frames. The rest of the AP MLDs in the MMLD may adjust their TSF based on the recently received TSF in the MMLD. In one example, the sharing/master AP MLD in the MMLD, may periodically broadcast its TSF. Other MLDs in the MMLD may adjust their TSF timers accordingly. In one example, AP MLDs in the MMLD may not adjust their TSF timer, instead, they report the TSF timer offset to each other (e.g., broadcast the TSF timer offset to each AP MLD in the MMLD). In one example, AP MLDs in the MMLD may not adjust their TSF timer, instead, they report the TSF timer offset to the sharing/master AP MLD. The sharing/master AP/AP MLD then may broadcast periodically the TSF timer offset between itself and each member AP/AP MLD. The TSF timer offset between any two member APs/AP MLDs may be obtained as difference of the corresponding TSF timer offsets of the two APs/AP MLDs. When the AP MLDs broadcast the TSF timer offsets, the non-AP STA or non-AP STA MLD may record the TSF timer offset for each AP/AP MLD it may be communicate with in the MMLD. This way, the non-AP STA/STA MLD may compensate the TSF timer offset if it gets the scheduling (e.g., TWT scheduling) from the AP/AP MLD in the MMLD. An AP or AP MLD affiliated with an AP MMLD may transmit the Beacon frames and Probe Response frames including a Reduced Neighbor Report element.

MMLD Information (e.g., MMLD Parameter subfield, MMLD element) may be included in the Reduced Neighbor Report (RNR) element. One or more values for target beacon transmit time (TBTT) Information Length subfield may be used to indicate MMLD related information may be carried in RNR element. For example, the TBTT Information field contents table may have an entry as shown in Table 1. TBTT Information Length subfield may indicate the contents carried in TBTT Information Set subfield.

TABLE 1
Entries for the contents of a modified TBTT Information field

| TBTT Information | |
|---|---|
| Length subfield value | TBTT Information field contents |
| X1 | The Neighbor AP TBTT Offset subfield and |
| | MMLD Parameters subfield |
| X2 | The Neighbor AP TBTT Offset subfield and |
| | MLD Parameters subfield and MMLD |
| | Parameters subfield |
| X3 | The Neighbor AP TBTT Offset subfield, the |
| | BSSID subfield, and the MMLD Parameter |
| | subfield |
| X4 | The Neighbor AP TBTT Offset subfield, the |
| | BSSID subfield, and the MLD Parameter |
| | subfield, and the MMLD Parameter subfield |
| X5 | The Neighbor AP TBTT Offset subfield, the |
| | BSSID subfield, the Short-SSID subfield, |
| | the BSS Parameters subfield, the 20 MHz |
| | PSD subfield and the MMLD Parameters |
| | subfield |
| X6 | The Neighbor AP TBTT Offset subfield, the |
| | BSSID subfield, the Short-SSID subfield, |
| | the BSS Parameters subfield, the 20 MHz PSD |
| | subfield and the MLD Parameters subfield, |
| | the 20 MHz PSD subfield and the MMLD |
| | Parameters subfield |

The TBTT Information field may have a format as shown in Table 2. The Neighbor AP TBTT Offset subfield nay indicate the offset in TUs, rounded down to nearest TU, If the MMLD Parameter subfield is present, the subfield may indicate the next TBTT of the reported AP from the immediately prior TBTT of the AP that transmits this element if the reported AP affiliate with the same MMLD as the reporting AP. The MMLD Parameters subfield may be present to indicate the MMLD related parameters. The MMLD Parameters subfield may be present when the TBTT Information Length subfield set to certain values (e.g., XZ1, X2, X3, X4, X5, or X6) as shown in Table 1.

TABLE 2
TBTT Information field with MMLD Parameters

| | | | | | | |
|---|---|---|---|---|---|---|
| Neighbor | BSSID | Short | BSS | 20 MHz | MLD | MMLD |
| AP TBTT | | SSID | Parameters | PSD | Parameters | Parameters |
| Offset | | | | | | |

The MMLD Parameters subfield may have a format as is shown in Table 3. A MMLD ID subfield may be used to identify the list of reported APs/AP MLDs affiliated to the same AP MMLD. If the reported AP/MLD is affiliated to the same MMLD as the reporting AP, the MMLD ID subfield may be set to a predefined value V1, e.g., V1=0. If the reported AP/MLD is not affiliated with any MMLD, the MMLD ID subfield may be set to a predefined value V2. If the reported AP/MLD is affiliated with another AP MMLD, the MMLD ID value may be set to uniquely identify the AP MMLD. The MMLD ID subfield may contain an identity of the MMLD with which the reported AP/AP MLD is affiliated. The MMLD ID may be locally or globally unique to identify a MMLD.

The MMLD ID subfield and the AP ID subfield may be combined (referred to collectively as MMLD/AP ID subfield) and may uniquely identify MMLDs and APs/MLDs. For example, if the reported AP/AP MLD is affiliated with MMLD1, the combination of MMLD ID and AP ID subfield (the combined value may be a function of the value in MMLD ID subfield and the value in AP ID subfield) may be set within a first range [a1,b1] to uniquely indicate MMLD1. For example, if the reported AP/AP MLD is affiliated with the same MMLD2, the combination of MMLD ID and AP ID subfield may be set within a second range [a2,b2] to uniquely indicate MMLD2. If the reported AP/MLD is not affiliated with any MMLD, the MMLD ID subfield may be set to a predefined value V2, for example.

An AP ID subfield may be used to indicate the AP/AP MLD within the AP MMLD uniquely. If the reported AP/AP MLD is not affiliated with any AP MMLD, the AP ID subfield may be set to a predefined value. A Synchronized MMLD subfield may indicate if the APs/AP MLDs within the MMLD may need to synchronize with each other. A Data Shared MMLD subfield may indicate if the data destined to one or more non-AP STAs/MLDs may need to be transmitted through more than one AP/AP MLD. An MMLD Parameter Change Count value of this subfield may increment when a critical update to the MMLD may occur. Alternatively, a combined MLD/MMLD Parameters subfield and/or MLD/MMLD element may be utilized. Note the MMLD Parameters subfield defined in Table 3 may be used in any field/element although a RNR element is used as an example here.

TABLE 3
MMLD Parameter subfield

| | | | | |
|---|---|---|---|---|
| MMLD ID | AP ID | Synchronized | Data | MMLD |
| | | MMLD | Shared | Parameter |
| | | | MMLD | Change |
| | | | | Count |

Regarding joint multi-access point (MAP) MLD transmissions, a Non-AP MLD may negotiate individual TWT agreements with an associated AP MLD, e.g., AP MLD1 on each link. Meanwhile, the AP MLD may notify the coordinating AP MLD(s), e.g., AP MLD2, of the updated TWT and initiate the joint transmission from coordinating/sharing AP MLD(s) to Non-AP MLD(s) which are all associated with AP MLD1 during Triggered-enabled TWT SP. This Trigger-enabled TWT service period (SP) may be called as Trigger-enabled TWT SP with MAP.

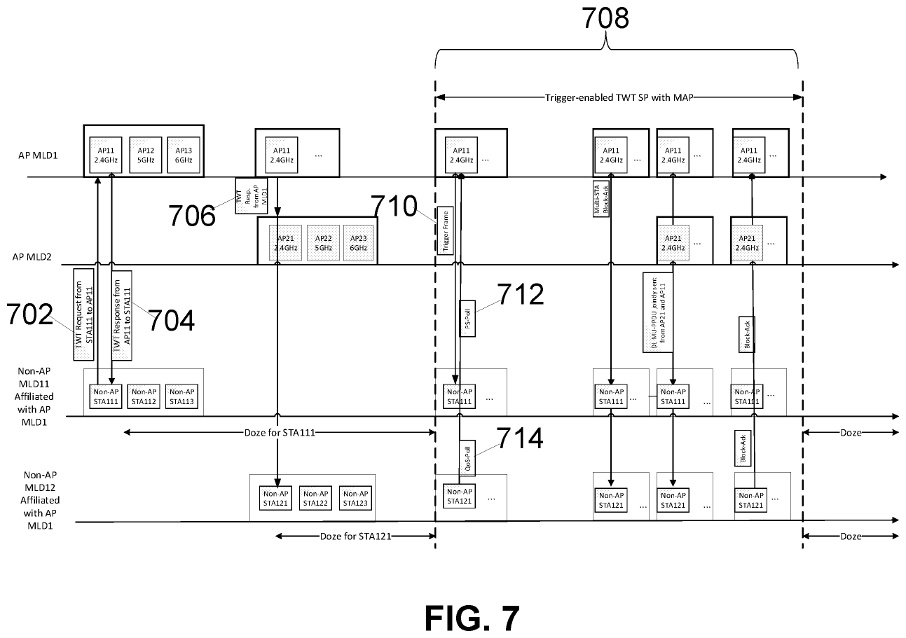

FIG. 7 is an example illustration of individual target wake time (TWT) operation in a Multi-MLD environment. A joint transmission from AP MLD1 and AP MLD2 to Non-AP MLD11 and Non-AP MLD12 is shown by the example. In this example, AP MLD1 operates on 3 links. AP11 operates on Link 1 (e.g., 2.4 GHZ), AP12 operates on Link 2 (e.g., 5 GHZ), and AP13 operates on Link 3 (e.g., 6 GHZ). Similarly, AP MLD2 operates on 3 links. AP21 operates on Link 1 (e.g., 2.4 GHz), AP22 operates on Link 2 (e.g., 5 GHZ), and AP23 operates on Link 3 (e.g., 6 GHZ). Non-AP MLD11 and Non-AP MLD12 both are affiliated with AP MLD1. They operate on 3 links. STA111 and STA121 operate on Link 1 (e.g., 2.4 GHZ). STA112 and STA122 operate on Link 2 (e.g. 5 GHZ). STA 113 and STA123 operate on Link 3 (e.g., 6 GHZ). Non-AP MLD11 may send a TWT request 702 to the TWT responding STA, i.e., AP MLD1, to set up a trigger-enabled TWT agreement on Link 1 (e.g., 2.4 GHZ). The TWT responding STA, i.e., AP MLD1, accepts the TWT agreement with MLD11 and confirms the acceptance in the TWT response 704 sent to MLD11 via Link 1. Subsequently, the TWT responding STA, i.e., AP MLD1, sends an unsolicited TWT response 706 to AP MLD2 and Non-AP MLD12 to set up a trigger-enabled TWT agreement with MLD12 on Link 1. This response is also used to notify AP MLD2 which is the coordinating AP with AP MLD1 of the next TWT with its associated STAs on Link 1. Both these TWT agreements are setup as announced TWTs on Link 1 (e.g., 2.4 GHZ). In other words, individual TWT agreements are set up on Link 1 between AP MLD1 Link 1 (AP11) and its associated STAs, i.e., non-AP STA111 and non-AP STA121. During the trigger-enabled TWT service period (SP) 708, the TWT responding STA, e.g., AP MLD1, sends a trigger frame 710 to which the TWT requesting STAs indicate that they are awake during the TWT SP 708 on Link 1. Non-AP STA111 indicates that it is awake by sending a PS-Poll frame 712 and Non-AP STA 121 indicates that it is awake by sending a QoS Null frame 714 in response to the trigger frame. Meanwhile, this trigger frame also is used to notify the cooperating AP MLD2 that the joint transmission is going to happen. STA111 and STA121 receive their DL buffer units (BUs) in a subsequent exchange with the TWT responding STA, AP11, and the coordinating AP21. They go to doze state outside this MAP TWT SP.

TWT elements may be link based,—each link may maintain its own TWT element. For example, the Target Wake Time field of the TWT element may indicate that Link 1 is in reference to the Timing Synchronization Function (TSF) time of Link 1. AP21 (Link 1 in AP MLD2) may synchronize with the TSF timer of AP11 first (e.g., adopt the TSF timer value of the parameters in a Beacon frame from AP11, or use the common TSF timer value of the parameters in the Beacon frame from the master AP MLD) and use the reference in the Target Wake Time subfield of the TWT element as the starting time to join the transmission with AP MLD1 AP11 in TWT SP. The common TSF timer value of the parameters in the Beacon frame from the master AP MLD may be shared among all AP MLDs within the same MAP set.

An AP MLD transmission may be sent to multiple STAs within the same MAP set. In one example embodiment, the Non-AP MLD may negotiate individual TWT agreements with an associated AP MLD, e.g., AP MLD1, on each link. Meanwhile, the AP MLD may notify the Non-AP MLD (e.g., MLD21) which is associated with another AP MLD within the same coordinating multi-AP (MAP) set of the updated TWT and start to provide service to the requesting TWT STA (e.g., MLD11) and the neighboring STA, e.g., MLD21, during Triggered-enabled TWT SP. This Trigger-enabled TWT SP may be referred to as Trigger-enabled TWT SP for associated STA(s) and Neighboring STA(s).

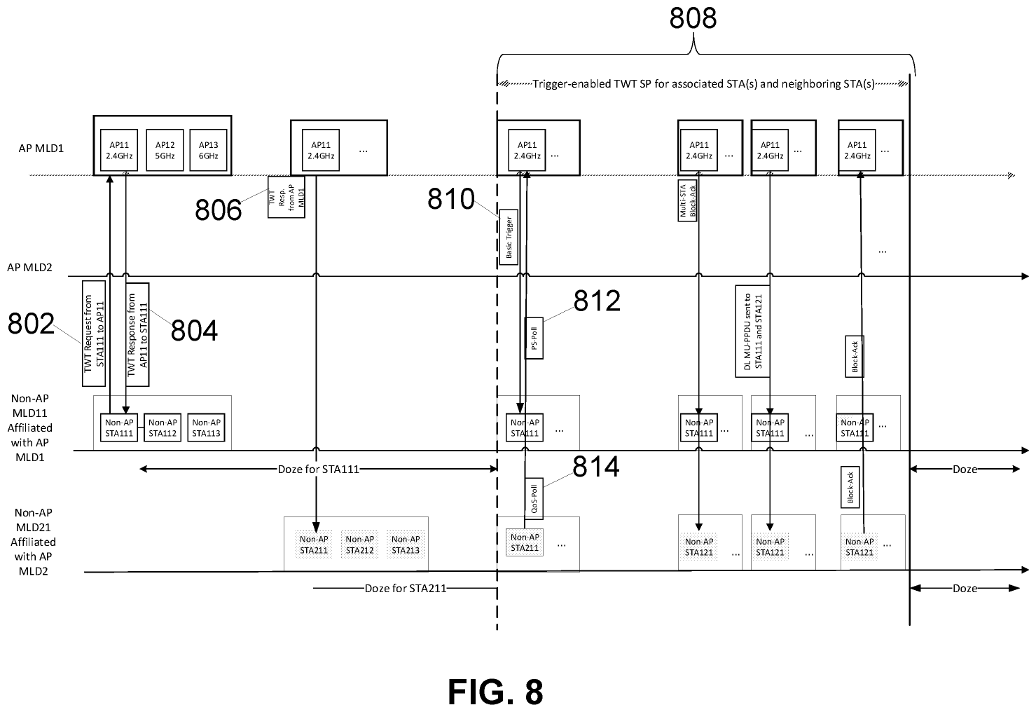

FIG. 8 is an example illustration of individual TWT operation in Multi-MLD environment where AP MLD1 provides service to STA MLD11 and STA MLD21. In this example, AP MLD1 and AP MLD2 operate on 3 links. AP11 and AP21 operate on Link 1 (e.g., 2.4 GHZ), AP12 and AP22 operate on Link 2 (e.g., 5 GHZ), and AP13 and AP23 operate on Link 3 (e.g., 6 GHZ). Non-AP MLD11 and Non-AP MLD21 are affiliated with AP MLD1 and AP MLD2 respectively. They both operate on 3 links. STA111 and STA211 operate on Link 1 (e.g., 2.4 GHZ). STA112 and STA212 operate on Link 2 (e.g., 5 GHZ), and STA 113 and STA213 operate on Link 3 (e.g., 6 GHZ). Non-AP MLD11 sends a TWT request 802 to the TWT responding STA, i.e., AP MLD1, to set up a trigger-enabled TWT agreement on Link 1, e.g., 2.4 GHz. The TWT responding STA, i.e., AP MLD1, accepts the TWT agreement with MLD11 and confirms the acceptance in the TWT response 804 sent to MLD11 via Link 1. Subsequently, the TWT responding STA, i.e., AP MLD1, sends an unsolicited TWT response 806 to AP MLD2 and Non-AP MLD21 to set up a trigger-enabled TWT agreement with MLD 21 on Link 1. This response also is used to notify AP MLD2 which is the coordinating AP with AP MLD 1 of the next TWT and it may provide the service to AP MLD2's associated STAs on Link 1. Both these TWT agreements are setup as announced TWTs on Link 1 (e.g., 2.4 GHZ). In other words, individual TWT is set up on Link 1 among AP MLD1 Link 1 (AP11), its associated STA(s), e.g., non-AP STA111 and neighboring STA(s), e.g., non-AP STA211. During the trigger-enabled TWT SP, the TWT responding STA, e.g., AP MLD1, sends a trigger frame 810 to which the TWT requesting STAs indicate that they are awake during the TWT SP on Link 1. Non-AP STA111 indicates that it is awake by sending a PS-Poll frame 812 and Non-AP STA 211 indicates that it is awake by sending a QoS Null frame 814 in response to the trigger frame. Meanwhile, this trigger frame also is used to notify the cooperating AP MLD2 that the transmission is going to happen to its associated STA. STA111 and STA211 receive their DL BUs in a subsequent exchange with the TWT responding STA, AP 11. They go to doze state outside this TWT SP 808.

There are multiple ways for STA MLD21 which are initially associate with AP MLD1 to be synchronized with AP MLD1 via TSF. One method is to have AP MLD2 synchronize with AP MLD1 via TSF and STA MLD21 gets timing synchronization with its associated AP, i.e., AP MLD2 through beacon. The other method is to have STA MLD21 directly synchronize with AP MLD1 on Link 1 as long as AP MLD1 and AP MLD2 are in the coordinating MAP set.

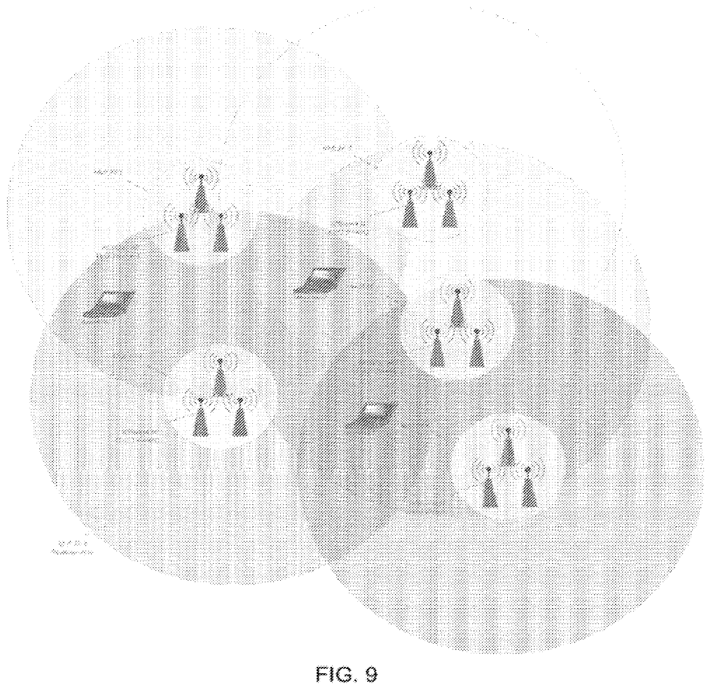

FIG. 9 is an architectural diagram illustrating various MLD APs. In the figure, the various MLD APs are labeled: “MLD AP 1”, “MLD AP 2”, etc., there are three non-AP MLDs also labeled “Non-AP MLD #”, the circles represent the coverage area of each of the MLD APs at their center, and the various shaded regions correspond to which MLD APs can serve each non-AP MLD. e.g., Non-AP MLD 1, is served by MLD AP 1 and MLD AP 4, while Non-AP MLD 3 is served by MLD AP 2, MLD AP 3, MLD AP 4, and MLD AP 5.—

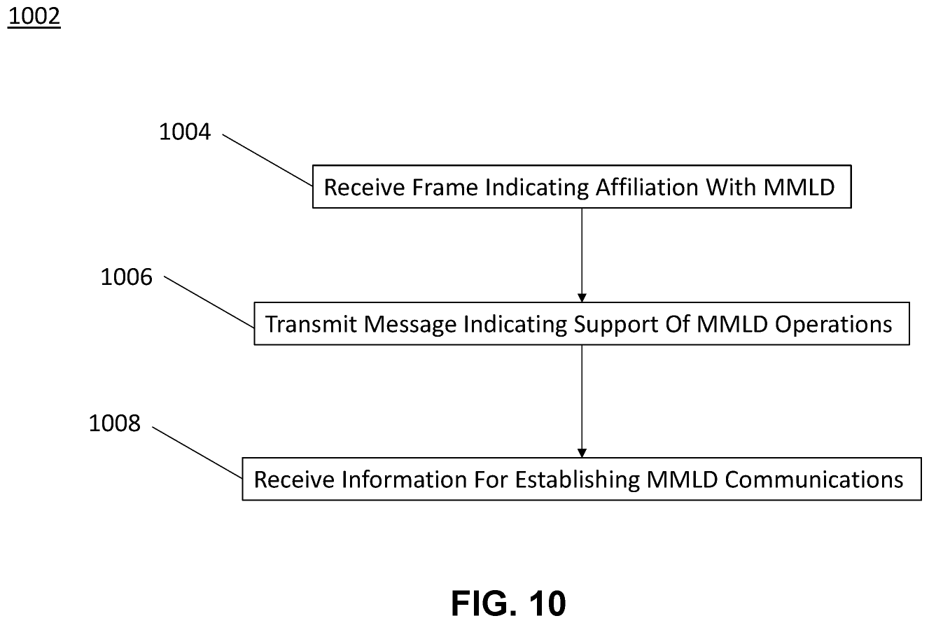

FIG. 10 depicts an example flow diagram summarizing a high-level process 1002 for performing multi-link operations as previously described herein. A frame may be received at step 1004. The frame may comprise any of the frames/elements/fields described herein. The frame may be provided by an AP MLD, for example. The frame may be received by a STA, an AP STA, a non-AP STA, a MLD, an AP MLD, a non-AP MLD, and/or any appropriate combination thereof, as described herein. The frame may provide an indication that the provider of the frame is affiliated with a plurality of AP MLDs, such as a MMLD. The MMLD affiliation may be indicated by any appropriate element and/or field in the frame, such as, for example, an element ID field, and/or an element ID extension field, as previously described herein. At step 1006, a message may be transmitted. The message may be provided by the recipient of the frame. The message may indicate that the recipient of the frame supports MMLD operations. The message may be provided to the entity that provided the frame, any of the plurality of AP MLDs, or any appropriate combination thereof. For example, an AP MLD may transmit the frame, a STA may receive the frame and respond directly to the AP MLD. Or, the STA may broadcast its response to all AP MLDs of the MMLD, including the AP MLD that provided the frame. At step 1008, information for establishing MMLD communications may be received. The information may be received by the recipient of the frame. The information may be received from the provider of the frame, and/or any of the AP MLDs of the MMLD.

Although the features and elements of the present invention are described in the preferred embodiments in particular combinations, each feature or element can be used alone without the other features and elements of the preferred embodiments or in various combinations with or without other features and elements of the present invention.

Although the solutions described herein consider 802.11 specific protocols, it is understood that the solutions described herein are not restricted to this scenario and are applicable to other wireless systems as well.

Although SIFS is used to indicate various inter frame spacing in the examples of the designs and procedures, all other inter frame spacing such as RIFS, AIFS, DIFS or other agreed time interval could be applied in the same solutions.

Although four RBs per triggered TXOP are shown in some figures as example, the actual number of RBs/channels/bandwidth utilized may vary.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods, apparatuses, and articles of manufacture, within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

Although foregoing embodiments may be discussed, for simplicity, with regard to specific terminology and structure, (e.g., radio frequency (RF), microwave, centimeter wave, micrometer wave, infrared (IR), ultraviolet (UV), visible light, etc.), the embodiments discussed, however, are not limited to thereto, and may be applied to other systems that use other forms of electromagnetic waves or non-electromagnetic waves such as acoustic waves, for example.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis, or the like, or any appropriate combination thereof. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to Figures. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media, which are differentiated from signals, include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of methods, apparatuses, articles of manufacture, and systems provided above are possible without departing from the scope of the invention. In view of the wide variety of embodiments that can be applied, it should be understood that the illustrated embodiments are examples only, and should not be taken as limiting the scope of the following claims. For instance, embodiments provided herein include handheld devices, which may include or be utilized with any appropriate voltage source, such as a battery or the like, providing any appropriate voltage.

Moreover, in embodiments provided herein, processing platforms, computing systems, controllers, and other devices containing processors are noted. These devices may contain at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples may be implemented, individually and/or collectively, by a wide range of hardware, software, firmware, or virtually any combination thereof. In example embodiments, several portions of the subject matter described herein may be implemented via Application Specific Integrated Circuits (ASICs), Field Programmable Gate Arrays (FPGAs), digital signal processors (DSPs), and/or other integrated formats. Those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. Those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

1-20. (canceled)

21. A method performed by a station (STA) configured to perform multi-link operations by communicating on a plurality of links concurrently, the method comprising:
receiving, from a first access point (AP) multi-link device (MLD), a frame comprising an indication that the first AP MLD is affiliated with a multi-MLD (MMLD) comprising a plurality of AP MLDs;
transmitting a message, wherein the message comprises an indication that the STA supports MMLD operations when concurrently communicating on the plurality of links; and
receiving first information related to one or more of the plurality of AP MLDs for establishing communications on the plurality of links.

22. The method of claim 21, further comprising providing second information to the first AP MLD, wherein the second information is configured to implement coordinated beamforming when concurrently communicating on the plurality of links.

23. The method of claim 21, further comprising providing second information to the first AP MLD, wherein the second information is configured to implement interference reduction when concurrently communicating on the plurality of links.

24. The method of claim 21, further comprising providing second information to the first AP MLD, wherein the second information is configured to implement spatial efficiency when concurrently communicating on the plurality of links.

25. The method of claim 21, wherein the frame is included in at least one of a beacon, a short beacon, a probe response, a fast initial link setup (FILS) discovery frame, or an association response frame.

26. The method of claim 21, wherein:
the frame comprises an MMLD element; and
the MMLD element comprises at least one of an element ID field, a length field, an element identifier (ID) field, and element ID extension field, a MMLD ID field, a MMLD media access control (MAC) Address field, a partial reporting field, a number of reported MLDs field, or a MLD information field.

27. The method of claim 21, further comprising:
providing a transmit wake time (TWT) request message to establish a TWT agreement; and
receiving a TWT response message comprising an indication that the TWT agreement is accepted.

28. The method of claim 27, wherein the STA is configured to communicate on the plurality of links in accordance with the TWT agreement.

29. The method of claim 21, further comprising transmitting the message to at least one of:
the first AP MLD; or
one or more of the plurality of AP MLDs.

30. The method of claim 21, wherein the first information for establishing communications on the plurality of links is provided by at least one of:
the first AP MLD; or
one or more of the plurality of AP MLDs.

31. A station (STA) configured to perform multi-link operations by communicating on a plurality of links concurrently, the STA comprising:
a transceiver; and
a processor configured to:
receive, via the transceiver, from a first access point (AP) multi-link device (MLD), a frame comprising an indication that the first AP MLD is affiliated with a multi-MLD (MMLD) comprising a plurality of AP MLDs;
transmit, via the transceiver, a message, wherein the message comprises an indication that the STA supports MMLD operations when concurrently communicating on the plurality of links; and
receive, via the transceiver, first information related to one or more of the plurality of AP MLDs for establishing communications on the plurality of links.

32. The STA of claim 31, the processor further configured to provide, via the transceiver, second information to the first AP MLD, wherein the second information is configured to implement coordinated beamforming when concurrently communicating on the plurality of links.

33. The STA of claim 31, the processor further configured to provide, via the transceiver, second information to the first AP MLD, wherein the second information is configured to implement interference reduction when concurrently communicating on the plurality of links.

34. The STA of claim 31, the processor further configured to provide, via the transceiver, second information to the first AP MLD, wherein the second information is configured to implement spatial efficiency when concurrently communicating on the plurality of links.

35. The STA of claim 31, wherein the frame is included in at least one of a beacon, a short beacon, a probe response, a fast initial link setup (FILS) discovery frame, or an association response frame.

36. The STA of claim 31, wherein:
the frame comprises an MMLD element; and
the MMLD element comprises at least one of an element ID field, a length field, an element identifier (ID) field, and element ID extension field, a MMLD ID field, a MMLD media access control (MAC) Address field, a partial reporting field, a number of reported MLDs field, or a MLD information field.

37. The STA of claim 31, the processor further configured to:
provide, via the transceiver, a transmit wake time (TWT) request message to establish a TWT agreement; and
receive, via the transceiver, a TWT response message comprising an indication that the TWT agreement is accepted.

38. The STA of claim 37, wherein the STA is configured to communicate on the plurality of links in accordance with the TWT agreement.

39. The STA of claim 31, further comprising transmitting the message to at least one of:
the first AP MLD; or
one or more of the plurality of AP MLDs.

40. The STA of claim 31, wherein the first information for establishing communications on the plurality of links is provided by at least one of:
the first AP MLD; or
one or more of the plurality of AP MLDs.
